(19) United States
(12) Patent Application Publication
(10) Pub. No.: US 2015/0004295 A1
(43) Pub. Date: Jan. 1, 2015

(54) PROCESSES FOR PREPARING FRUIT AND VEGETABLE SNACKS

(71) Applicant: PAISAL ANGKHASEKVILAI, PARKRED NONTABURI (TH)

(72) Inventor: PAISAL ANGKHASEKVILAI, PARKRED NONTABURI (TH)

(21) Appl. No.: 13/929,300

(22) Filed: Jun. 27, 2013

(51) Int. Cl. A23L 1/00; A23L 1/212

(52) U.S. Cl. CPC A23L 1/0002; A23L 1/212
USPC 426/489

(57) ABSTRACT

A process for preparing concentrated food products including using a centrifugal evaporator to for a concentrated food mixture that can be passed through an extruder to form a final concentrated food product. The concentrated food product is made of 100 weight percent fruit and vegetables wherein no sugar is added during the production process. The concentrated food product contains less than 20 weight percent water and provide an excellent source of vitamins and nutrients.

### FIELD OF THE INVENTION

The present invention relates to concentrated snack products made from fruits and vegetables and, in particular, to processes for preparing concentrated fruit and vegetable snacks.

### BACKGROUND

Fruits and vegetables are a healthy choice that provides an excellent source of dietary fiber, vitamins, minerals, etc, to consumers. Fruits and vegetables are often dehydrated to form healthy snacks. The dehydrated food products have a very low water content and the dehydration process can degrade the food to deplete the natural sources of nutrients. Concentration of food products can offer a better alternative to dehydrated food products. Moreover, food in the concentrated state generally remains in the liquid state, whereas drying produces solid or semi-solid food with significantly lower water content. There is a need to develop an efficient and robust process that provides valuable concentrated food products that can offer 100% natural nutrients to consumers.

### BRIEF SUMMARY OF THE INVENTION

A process for preparing a concentrated food product including the steps of feeding a food mixture of fruit, vegetable or a combination thereof into a centrifugal evaporator. The food mixture to be fed into the centrifugal evaporator is made preferably from 100 weight percent natural fruit and/or vegetable with no other ingredients, such as sugar, being added. The process further includes concentrating the food mixture in the centrifugal evaporator to form a concentrated food mixture. The concentrated food mixture can be passed through an extruder to form an extruded, concentrated food mixture that can be further cooled to yield a concentrated food product.

A process for preparing a concentrated food product including the steps of preparing a food mixture consisting entirely of fruits, vegetables or a mixture thereof. The food mixture can be fed into a thin-film, spinning cone evaporator to form a concentrated food mixture. The concentrated food mixture is concentrated under vacuum in the evaporator at a temperature in the range of 40 to 60° C. The concentrated food mixture can have a sugar content in the range of 60 to 90 degrees Brix and a water content in the range of 15 to 25 weight percent, and preferably less than 20 weight percent. The concentrated food mixture can be passed through a twin screw extruder having three separate temperature zones for processing the concentrated food mixture. The three temperature zones include a feed entry, a mixing section and a die exit. The concentrated food mixture can be processed at a temperature in the range of 100 to 150° C. in all three temperature zones to form an extruded, concentrated food mixture. The extruded, concentrated food mixture can be cooled to a temperature in the range of 20 to 25° C. to form a concentrated food product.

### BRIEF DESCRIPTION OF THE DRAWINGS

The following figures illustrate various aspects of one or more embodiments of the present invention, but are not intended to limit the present invention to the embodiments shown.

FIG. 1 shows a diagram of an evaporation system using a centrifugal evaporator for preparing a concentrated food mixture.

FIG. 2 shows an extruder for processing a concentrated food mixture to produce an extruded, concentrated food mixture.

FIG. 3A shows an example of a die plate for use with an extruder for shaping a concentrated food mixture.

FIG. 3B shows an example of a die plate for use with an extruder for shaping a concentrated food mixture.

FIG. 4 shows a process for preparing a concentrated food product from 100% natural fruits and vegetables.

### DETAILED DESCRIPTION

As used herein, when a range such as 5-25 is given, this means at least or more than 5 and, separately and independently, not more or less than 25.

Concentrated fruit and vegetable food products or snacks disclosed herein are preferably composed of 100 weight percent natural fruits and vegetables and preferably are substantially free of other non-fruit or -vegetable ingredients, such as artificial sugars, etc. The concentrated fruit and vegetable food products can be a single fruit (e.g., pineapple concentrate); or from single vegetable (e.g., carrot concentrate); or from one or more fruits combined fractions of a different fruits and/or vegetables (e.g., pineapple concentrate and apple concentrate and optionally combined with a fruit and/or vegetable puree). These combinations of concentrated fruits, vegetables, purees and the like can be incorporated into a formulation to achieve certain functional properties, such as enhanced fiber, minerals, vitamins and the like. The concentrated fruit and vegetable food products or snacks disclosed herein can alternatively contain less than 100 weight percent natural fruits and vegetables, such as other ingredient besides natural fruits and vegetables can be at least 1, 2, 3, 4, 5, 10, 15, 20 or 25 weight percent of the concentrated food product.

The concentrated food product can contain at least 80, 85, 90, 95, 96, 97, 98, 99, 99.5 or 100 weight percent of solid fruits, vegetables or a combination thereof. The concentrated food product can have a low water activity, for example, less than 0.5. The concentrated food product can also have a low water content, for example, in the range of 1 to 20 or 10 to 15 or 12 to 14 weight percent or less than 20, 15, 10 or 5 weight percent. An example of a concentrated food product includes a formulation of 96 weight percent fruit solids, 3 weight percent glycerin and 1 weight percent water.

The sugar content of the food mixtures and concentrated food products discussed herein is measured in degrees Brix. Brix is usually considered equivalent to the percentage of sucrose in a solution. The concentrated food product can have a sugar content in the range of 60 to 90, and preferably 75 to 85 degrees Brix.

Processes for preparing the concentrated food product are described below. A food mixture for processing can be prepared by mixing one or more natural fruits, vegetables or a combination thereof to form a feed food mixture. The food mixture is preferably pumpable and can be a puree, juice, liquid slurry or dispersion. The food mixture can be fed into a centrifugal evaporator, such as a thin-film, spinning cone evaporator. One example of a centrifugal evaporator includes a Centritherm® evaporator. It is desirable that a centrifugal evaporator suitable for processing heat-sensitive food products, such as those made from fruits and vegetables, is selected for preparing the concentrated food product. Further, a centrifugal evaporator that can process viscous, high value products of color, functionality and flavor, such as fruits and vegetables is desirable.

During processing to concentrate the food mixture, the food mixture can be spread centrifugally on a spinning heated cone. The spinning cone can form a food mixture film of less than 1 mm. The film can have a heat contact time of approximately 1 second or less on the heat transfer surface during processing. The centrifugal force generated by the spinning cone can create thin product films that permit higher concentrations of food mixtures as compared to conventional evaporators.

The food mixture can be concentrated in the centrifugal evaporator such that it has a sugar content in the range of 45 to 90, preferably 60 to 90 and preferably 75 to 85 degrees Brix. Prior to being concentrated, the food mixture can have a sugar content in the range of 20 to 45 degrees Brix. The food mixture is preferably concentrated in the centrifugal evaporator so the sugar content of the food mixture is increased at least 50, 60, 70, 80, 90, 95 or 100 percent. For example, pineapple juice can be concentrated from 45 degrees Brix to 80 degrees Brix in a single pass through the centrifugal evaporator. The food mixture can be passed through the centrifugal evaporator 1, 2, 3, 4 or 5 times or as desired.

The food mixture can be processed in the centrifugal evaporator at a temperature in the range of 40 to 65, or about 50° C. The temperature range is gentle enough to concentrate functional ingredients, such as vitamins, polyphenols and anthocyanins with minimal to no degradation. The centrifugal evaporator also is beneficial because it does not affect natural colors due its low thermal impact. Raw materials that can be processed on a commercial scale include various oleoresins, beetroot, carrot, blueberry, pineapple, tomato and more.

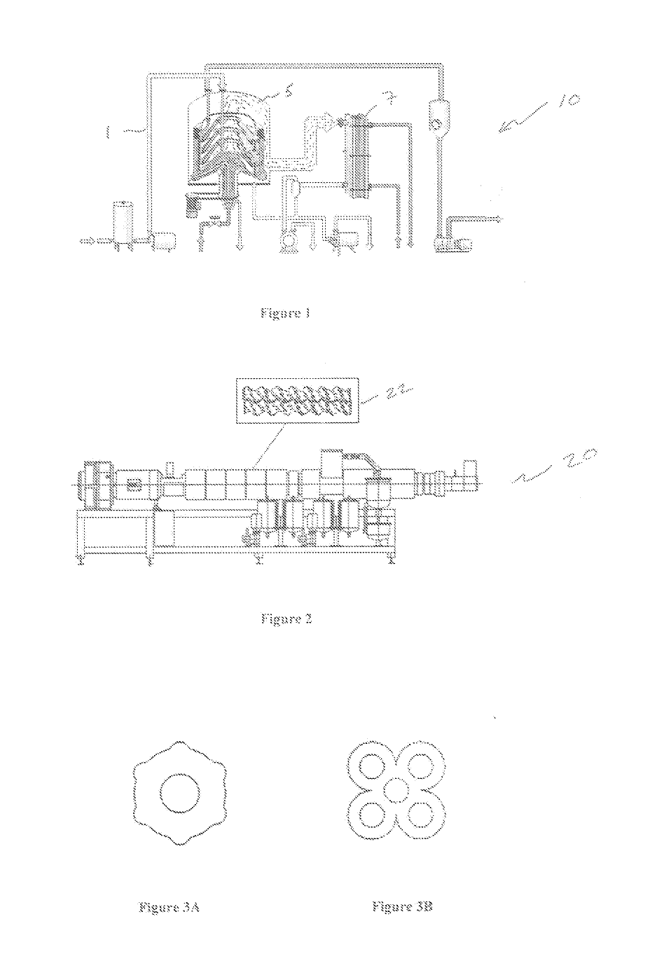

Food mixtures in the form of juices can be fed into the centrifugal evaporator at a rate of 250-400 l/hr. To heat the food mixture in the centrifugal evaporator, steam at a pressure of 80 to 120 kPa can be used to achieve a food mixture temperature of 40 to 65° C. FIG. 1 shows a diagram of an evaporation system 10 using a centrifugal evaporator.

As shown, variable speed pumps can be used to transfer food mixture 1 into the centrifugal evaporator 5. The food mixture can be passed through a heat exchanger 7, such as those supplied by Spiraflo, where the food mixture, such as juice, is heated to a temperature in the range of 50 to 65° C. and then transferred into the feed tube to inject the food mixture inside the surface of the cone, close to the axis. The food mixture flows down the surface of the cone as a thin, fast moving, evaporating liquid film under centrifugal force caused by the rotation of the cone. The heating surface consists of rotating cones, which by combining heat and centrifugal force, provide a high degree of concentration to the food mixture in one single pass in very low temperature and very short time (STLT) (e.g., 55° C., 10 seconds). The concentrated fruits and vegetables juice can be pumped out by mono pump and the vapor passed through a vapor chamber to the condenser, from which the condensate can pumped out by a centrifugal pump. To make a recycle of fruits and vegetables juice in the system and maintain the constant concentration of the fruits and vegetables juice concentrate, the vapor condensate can be fed back to the feed container and the finished juice concentrate product can have a moisture content of 30-50 weight percent and 50-70 degrees Brix. Although not show, the concentrated food mixture can be transferred to a mixing tank before being extruded. Fruit and vegetable blends can be prepared in the mixing tank. Prior to being extruded, it is preferred that the concentrated food mixture have a sugar content in the range of 75 to 85 degrees Brix and a moisture content in the range of 20 to 25 weight percent.

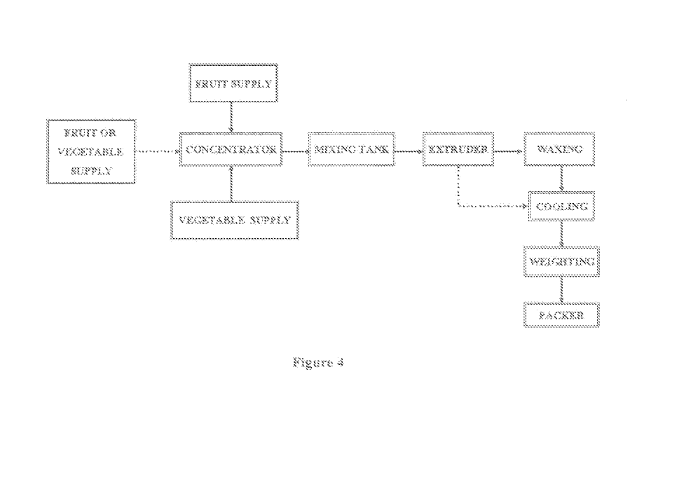

The concentrated food mixture can be passed through an extruder, such as a twin screw extruder 20 capable of counter rotation. The extruder can be capable of heating and cooking the concentrated food mixture. Extrusion cooking can provide a high temperature/short time process to produce fiber-rich food products. In the extruder, the concentrated food mixture is thermomechanically cooked to high temperature, pressure and subjected to shear stresses generated by the screw-barrel assembly 22, for example, as shown in FIG. 2. The extruder can also impart an extruded shape for producing the concentrated food product. FIGS. 3A and 3B show examples of die plates that can be used at the extruder die exit to impart a particular shape to the extruded food product. Different shapes can include bars, strips, bites, belts and hollow fruit or vegetable cables. Further, extruders can be used to cook, form, mix, texturize, and shape food product under condition retention flavor quality, high productivity, relative low cost, energy efficiency and lack of effluents.

The concentrated food mixture can be fed into the extruder at a rate of 15 to 300 kg/hr. The extruder can have a screw-barrel assembly that can operate at 17 to 25 rpm. The extruder can have sections or temperature zones for processing and cooking the concentrated food mixture. For example, the extruder can have a feed entry temperature zone that can process the concentrated food mixture at a temperature in the range of 30 to 120° C. The extruder can further have a mixing section temperature zone that can process the concentrated food mixture at a temperature in the range of 125 to 150° C. The extruder can further have a die exit temperature zone that can process the concentrated food mixture at a temperature in the range of 125 to 150° C.

The extruded, concentrated food mixture can be cooled to form a concentrated food product. Preferably, the extruded, concentrated food mixture, at a temperature in the range of 100 to 150° C., can be cooled to a temperature in the range of 20 to 25° C. at a relative humidity of 45-50 percent. For example, the extruded, concentrated food mixture can be distributed evenly out of the die exit onto a belt of a cooling tunnel. The cooled concentrated food product can be cut, weighed and stored or packaged in bags, such as metalized bags, at room temperature.

In an embodiment, a process for preparing a concentrated food product is shown in FIG. 4. A food mixture, in the form of a fruit supply, vegetable supply or a combination of fruit and vegetable supply is fed into a concentrator, such as a centrifugal evaporator as discussed above. The concentrated food mixture can be fed to a mixing tank before being extruded, for example, in a twin screw extruder. The extruded, concentrated food mixture can be optionally subjected to a waxing process or directly cooled, such as in a cooling tunnel to yield a concentrated food product that can be further weighed, cut and packaged.

In order to promote a further understanding of the invention, the following examples are provided. These examples are shown by way of illustration and not limitation.

### EXAMPLE 1

Production of a concentrated food product. A food mixture was prepared by combining 100% natural fruit and vegetable juice and puree. The food mixture was fed into a Centritherm® Evaporator Model CT-6 to concentrate the food mixture to 45-65 degrees Brix. Then, concentrated food mixture was transferred into a mixing tank and mixed at 55° C. for 45 minutes. The concentrated food mixture was then fed into the feed throat of twin screw extruder. No liquid was added; the native juice concentrate having 20-25% residual moisture provided adequate moisture for extrusion processing. From in-feed section to exit die, the temperatures in the extrusion increased from 30 to 120° C. in the feed section, to 125 to 150° C. at the die, The extrudate was conveyed to a cooling tunnel, cooling the extrudate at 20 to 25° C. for 10-15 minutes. The extruded, concentrated food mixture was dried to 14% moisture content to yield a 100% natural concentrated food product. The concentrated food product weighed about 21 grams and had water activity of less than 0.5. The concentrated food product was packaged immediately in metalized bags to prevent moisture pickup from the air.

### EXAMPLE 2

A concentrated food product made of 100% natural carrot was made by the process of Example 1. Three carrot source: carrot puree, carrot concentrated, carrot fiber, was prepared as the food mixture by mixing in a mixing tank for 45 min at proportions of 50%, 45% and 5%, respectively.

### EXAMPLE 3

A concentrated food product made of 100% natural tomato was made by the process of Example 1.

### EXAMPLE 4

A concentrated food product made of 100% natural apple was made by the process of Example 1.

### EXAMPLE 5

The concentrated food product of Example 1 was prepared by adding calcium to the food mixture.

### EXAMPLE 6

The concentrated food product of Example 1 was prepared by adding vitamin C to the food mixture.

### EXAMPLE 7

The concentrated food product of Example 1 was prepared by adding fiber to the food mixture.

### EXAMPLE 8

The concentrated food product of Example 1 was prepared by adding an antioxidant to the food mixture.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modification as encompassed by the scope of the appended claims.

What is claimed is:

1. A process for preparing a concentrated food product, the process comprising:
feeding a food mixture comprising fruit, vegetable or a combination thereof into a centrifugal evaporator;
concentrating the food mixture in the centrifugal evaporator to form a concentrated food mixture;
passing the concentrated food mixture through an extruder to form an extruded, concentrated food mixture.

2. The process of claim 1, further comprising transferring the concentrated food mixture to a mixing tank prior to passing the concentrated food mixture to the extruder.

3. The process of claim 1, the food mixture having sugar content in the range to 20 to 45 degrees Brix.

4. The process of claim 1, the concentrated food mixture having a sugar content in the range of 45 to 90 Brix.

5. The process of claim 4, the concentrated food mixture having a sugar content in the range of 75 to 85 degrees Brix.

6. The process of claim 1, the concentrated food mixture having a moisture content in the range of 30 to 50 weight percent.

7. The process of claim 6, the concentrated food mixture having a moisture content in the range of 15 to 25 weight percent.

8. The process of claim 1, the food mixture being passed through the centrifugal evaporator once, wherein the concentrated food mixture formed by the single pass through the centrifugal evaporator has a moisture content in the range of 20 to 25 weight percent and a sugar content in the range of 70 to 85 degrees Brix before being passed through the extruder.

9. The process of claim 1, the food mixture being processed in the centrifugal evaporator at a temperature in the range of 40 to 65° C., the food mixture being concentrated under vacuum.

10. The process of claim 1, the centrifugal evaporator being a thin-film, spinning cone evaporator suitable for process heat-sensitive food products.

11. The process of claim 1, the concentrated food mixture being heated to a temperature of at least 100° C. at the feed entry of the extruder.

12. The process of claim 1, the concentrated food mixture being at a temperature in the range of 125 to 150° C. in the mixing zone of the extruder.

13. The process of claim 1, the extruded, concentrated food mixture being at a temperature in the range of 125 to 150° C., the extruded, concentrated food mixture further being to a temperature in the range of 20 to 25° C. to form a concentrated food product.

14. The process of claim 13, the concentrated food product having a moisture content in the range of 10 to 18 weight percent.

15. The process of claim 14, the concentrated food product having a water activity of less than 0.5.

16. The process of claim 13, the concentrated food product being 100 weight percent natural fruit, vegetable or a combination thereof, wherein no sugar is added to the fruit, vegetable or combination thereof during the process of preparing the concentrated food product.

17. A process for preparing a concentrated food product, the process comprising:
preparing a food mixture consisting entirely of fruits, vegetables or a mixture thereof;
feeding the food mixture in a thin-film, spinning cone evaporator to form a concentrated food mixture, the food mixture being concentrated under vacuum at a temperature in the range of 40 to 60° C., the concentrated food mixture having a sugar content in the range of 60 to 90 degrees Brix and a water content in the range of 15 to 25 weight percent;
passing the concentrated food mixture through twin screw extruder having three temperature zones for processing the concentrated food mixture, the three temperature zones being a feed entry, a mixing section and a die exit, the concentrated food mixture being process at a temperature in the range of 100 to 150° in all three temperature zones to form an extruded, concentrated food mixture;
cooling the extruded, concentrated food mixture to a temperature in the range of 20 to 25° C. to form a concentrated food product

18. The process of claim 17, the concentrated food product having a moisture content in the range of 10 to 18 weight percent.

19. The process of claim 17, the concentrated food product having a water activity of less than 0.5.

20. The process of claim 17, the concentrated food product being 100 weight percent natural fruit, vegetable or a combination thereof, wherein no sugar is added to the fruit, vegetable or combination thereof during the process of preparing the concentrated food product.
